(19) United States
(12) Patent Application Publication
(10) Pub. No.: US 2012/0020946 A1
(43) Pub. Date: Jan. 26, 2012

(54) Methods for Inactivating Viruses

(75) Inventors: Morten Gjermansen, Greve (DK); Rikke Festersen, Herlev (DK); Steffen Danielsen, Copenhagen Oe (DK); Marie Allesen-Holm, Hilleroed (DK)

(73) Assignee: NOVOZYMES A/S, Bagsvaerd (DK)

(21) Appl. No.: 13/259,843

(22) PCT Filed: Mar. 26, 2010
(86) PCT No.: PCT/EP10/54029

§ 371 Date: Sep. 23, 2011

(30) Foreign Application Priority Data
Apr. 3, 2009 (EP) 09157351.9
Apr. 22, 2009 (EP) 09158525.7

(51) Int. Cl. A01N 63/04; A01P 1/00

(52) U.S. Cl. 424/94.4

(57) ABSTRACT

The present invention provides a method for inactivating viruses, by contacting the viruses with a haloperoxidase, hydrogen peroxide, chloride ions, bromide ions, and ammonium ions.

### FIELD OF THE INVENTION

The present invention relates to enzymatic methods for inactivating viruses, and for disinfecting or sterilizing medical devices and equipment.

### BACKGROUND

Most fungi, viruses and vegetative cells of pathogenic bacteria are killed or inactivated within minutes at 70 degrees Celsius; however, some pathogenic viruses, such as polio virus, are much more difficult to inactivate. Moreover, since sensitive medical equipment often has a reduced service life when exposed to such elevated temperatures, it is desirable to use a method for disinfection of medical equipment which employs lower temperatures and mild conditions, while retaining the virus inactivating capabilities.

Of particular concern are the small non-enveloped viruses, such as poliovirus, parvovirus and hepatitis A virus. These are small (23-27 nanometers in diameter), non-enveloped human pathogens, which have been demonstrated to be resistant to the removal and inactivation procedures that show efficacy against lipid-enveloped viruses such as HIV, hepatitis B, and hepatitis C virus.

A highly stable sub-class of the small non-enveloped viruses is the Enteroviruses (e.g. poliovirus and hepatitis A virus), which are resistant to pH levels below three, detergents, 70% alcohol, and other lipid solvents, such as chloroform and ether. Since they also resist disinfectants like 5% Lysol and 1% quaternary ammonium compounds, the enteroviruses are particularly difficult to inactivate.

The present invention provides an improved enzymatic method for inactivating viruses, which is more gentle on sensitive materials, such as medical equipment, than traditional methods.

### SUMMARY

The present invention provides a method for inactivating a virus, comprising contacting the virus with a haloperoxidase, a source of hydrogen peroxide, chloride ions and/or bromide ions, and ammonium ions.

In an embodiment, the haloperoxidase is a chloroperoxidase or a bromoperoxidase. In another embodiment the haloperoxidase is a vanadium containing haloperoxidase.

### DETAILED DESCRIPTION

### Haloperoxidases and Compounds Exhibiting Haloperoxidase Activity

The haloperoxidases suitable for being incorporated in the method of the invention include chloroperoxidases, bromoperoxidases and compounds exhibiting chloroperoxidase or bromoperoxidase activity. Haloperoxidases form a class of enzymes, which are capable of oxidizing halides (Cl—, Br—, I—) in the presence of hydrogen peroxide or a hydrogen peroxide generating system to the corresponding hypohalous acids.

Haloperoxidases are classified according to their specificity for halide ions. Chloroperoxidases (E.C. 1.11.1.10) catalyze formation of hypochlorite from chloride ions, hypobromite from bromide ions and hypoiodite from iodide ions; and bromoperoxidases catalyze formation of hypobromite from bromide ions and hypoiodite from iodide ions. Hypoiodite, however, undergoes spontaneous disproportionation to iodine and thus iodine is the observed product. These hypohalite compounds may subsequently react with other compounds forming halogenated compounds.

In a preferred embodiment, the haloperoxidase of the invention is a chloroperoxidase.

Haloperoxidases have been isolated from various organisms: mammals, marine animals, plants, algae, lichen, fungi and bacteria. It is generally accepted that haloperoxidases are the enzymes responsible for the formation of halogenated compounds in nature, although other enzymes may be involved.

Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis.

Haloperoxidases have also been isolated from bacteria such as Pseudomonas, e.g., P. pyrrocinia and Streptomyces, e.g., S. aureofaciens.

In a preferred embodiment, the haloperoxidase is a vanadium haloperoxidase (i.e. a vanadium or vanadate containing haloperoxidase) derivable from Curvularia sp., in particular Curvularia verruculosa or Curvularia inaequalis, such as C. inaequalis CBS 102.42 as described in WO 95/27046, e.g. a vanadium haloperoxidase encoded by the DNA sequence of WO 95/27046, FIG. 2 all incorporated by reference; or C. verruculosa CBS 147.63 or C. verruculosa CBS 444.70 as described in WO 97/04102. Preferably, the amino acid sequence of the haloperoxidase has at least 90% identity, preferably 95% identity to the amino acid sequence of a haloperoxidase obtainable from Curvularia verruculosa (see e.g. SEQ ID NO:2 in WO 97/04102) or Curvularia inequalis (e.g. the mature amino acid sequence encoded by the DNA sequence in FIG. 2 of WO 95/27046).

In another preferred embodiment the haloperoxidase is a vanadium containing haloperoxidase; in particular a vanadium chloroperoxidase. The vanadium chloroperoxidase may be derivable from Drechslera hartlebii as described in WO 01/79459, Dendryphiella salina as described in WO 01/79458, Phaeotrichoconis crotalarie as described in WO 01/79461, or Geniculosporium sp. as described in WO 01/79460. The vanadium haloperoxidase is more preferably derivable from Drechslera hartlebii (DSM 13444), Dendryphiella salina (DSM 13443), Phaeotrichoconis crotalarie (DSM 13441) or Geniculosporium sp. (DSM 13442).

The concentration of the haloperoxidase is typically in the range of 0.01-100 ppm enzyme protein, preferably 0.05-50 ppm enzyme protein, more preferably 1-40 ppm enzyme protein, more preferably 0.1-20 ppm enzyme protein, and most preferably 0.5-10 ppm enzyme protein.

In an embodiment, the concentration of the haloperoxidase is typically in the range of 5-50 ppm enzyme protein, preferably 5-40 ppm enzyme protein, more preferably 8-32 ppm enzyme protein.

### Determination of Haloperoxidase Activity

An assay for determining haloperoxidase activity may be carried out by mixing 100 μL of haloperoxidase sample (about 0.2 μg/mL) and 100 μL of 0.3 M sodium phosphate pH 7 buffer—0.5 M potassium bromide—0.008% phenol red, adding the solution to 10 μL of 0.3% H₂O₂, and measuring the absorption at 595 nm as a function of time.

Another assay using monochlorodimedone (Sigma M4632, ε=20000 M⁻¹ cm⁻¹ at 290 nm) as a substrate may be carried out by measuring the decrease in absorption at 290 nm as a function of time. The assay is done in an aqueous solution of 0.1 M sodium phosphate or 0.1 M sodium acetate, 50 μM monochlorodimedone, 10 mM KBr/KCl, 1 mM H₂O₂ and about 1 μg/mL haloperoxidase. One haloperoxidase unit (HU) is defined as 1 micromole of monochlorodimedone chlorinated or brominated per minute at pH 5 and 30° C.

### Hydrogen Peroxide

The hydrogen peroxide required by the haloperoxidase may be provided as an aqueous solution of hydrogen peroxide or a hydrogen peroxide precursor for in situ production of hydrogen peroxide. Any solid entity which liberates upon dissolution a peroxide which is useable by haloperoxidase can serve as a source of hydrogen peroxide. Compounds which yield hydrogen peroxide upon dissolution in water or an appropriate aqueous based medium include but are not limited to metal peroxides, percarbonates, persulphates, perphosphates, peroxyacids, alkyperoxides, acylperoxides, peroxyesters, urea peroxide, perborates and peroxycarboxylic acids or salts thereof.

Another source of hydrogen peroxide is a hydrogen peroxide generating enzyme system, such as an oxidase together with a substrate for the oxidase. Examples of combinations of oxidase and substrate comprise, but are not limited to, amino acid oxidase (see e.g. U.S. Pat. No. 6,248,575) and a suitable amino acid, glucose oxidase (see e.g. WO 95/29996) and glucose, lactate oxidase and lactate, galactose oxidase (see e.g. WO 00/50606) and galactose, and aldose oxidase (see e.g. WO 99/31990) and a suitable aldose.

By studying EC 1.1.3._, EC 1.2.3._, EC 1.4.3._, and EC 1.5.3._ or similar classes (under the International Union of Biochemistry), other examples of such combinations of oxidases and substrates are easily recognized by one skilled in the art.

Hydrogen peroxide or a source of hydrogen peroxide may be added at the beginning of or during the process, e.g., typically in an amount corresponding to levels of from 0.001 mM to 25 mM, preferably to levels of from 0.005 mM to 5 mM, and particularly to levels of from 0.01 to 1 mM hydrogen peroxide. Hydrogen peroxide may also be used in an amount corresponding to levels of from 0.1 mM to 25 mM, preferably to levels of from 0.5 mM to 15 mM, more preferably to levels of from 1 mM to 10 mM, and most preferably to levels of from 2 mM to 8 mM hydrogen peroxide.

### Chloride and Bromide Ions

According to the invention, the chloride and/or bromide ions (Cl⁻ and/or Br⁻) needed for the reaction with the haloperoxidase may be provided in many different ways, such as by adding salts of chloride and/or bromide. In a preferred embodiment the salts of chloride and bromide are sodium chloride (NaCl), sodium bromide (NaBr), potassium chloride (KCl), potassium bromide (KBr), ammonium chloride (NH₄Cl) or ammonium bromide (NH₄Br); or mixtures thereof.

In an embodiment, the chloride and/or bromide ions are limited to only chloride ions (Cl⁻) or bromide ions (Br⁻). In another embodiment, the chloride and/or bromide ions are limited to only chloride ions (Cl⁻) and bromide ions (Br⁻). The chloride ions may be provided by adding a salt of chloride to an aqueous solution. The salt of chloride may be sodium chloride, potassium chloride or ammonium chloride; or a mixture thereof. The bromide ions may be provided by adding a salt of bromide to an aqueous solution. The salt of bromide may be sodium bromide, potassium bromide or ammonium bromide; or a mixture thereof.

The concentration of each of chloride and bromide ions are typically in the range of from 0.01 mM to 1000 mM, preferably in the range of from 0.05 mM to 500 mM, more preferably in the range of from 0.1 mM to 100 mM, most preferably in the range of from 0.1 mM to 50 mM, and in particular in the range of from 1 mM to 25 mM. The concentration of chloride ions is independent of the concentration of bromide ions; and vice versa.

In an embodiment, the molar concentration of each of chloride and bromide ions is at least two times higher, preferably at least four times higher, more preferably at least six times higher, most preferably at least eight times higher, and in particular at least ten times higher than the concentration of ammonium ions.

### Ammonium Ions

The ammonium ions (NH₄⁺) needed to inactivate viruses according to the methods of the invention may be provided in many different ways, such as by adding a salt of ammonium. In a preferred embodiment the ammonium salt is ammonium sulphate ((NH₄)₂SO₄), ammonium carbonate ((NH₄)₂CO₃), ammonium chloride (NH₄Cl), ammonium bromide (NH₄Br), or ammonium iodide (NH₄I); or a mixture thereof.

The concentration of ammonium ions is typically in the range of from 0.01 mM to 1000 mM, preferably in the range of from 0.05 mM to 500 mM, more preferably in the range of from 0.1 mM to 100 mM, most preferably in the range of from 0.1 mM to 50 mM, and in particular in the range of from 1 mM to 25 mM.

### Viruses

The viruses, which are inactivated with a haloperoxidase, hydrogen peroxide, chloride ions and/or bromide ions, and ammonium ions according to the invention, comprise all kinds of viruses.

In an embodiment the viruses are selected from the group consisting of: Adenoviruses, Arenaviruses, Bunyaviruses, Caliciviruses, Coronaviruses, Deltaviruses, Filoviruses, Flaviviruses, Hepadnaviruses, Herpesviruses, Orthomyxoviruses, Papovaviruses, Paramyxoviruses, Parvoviruses, Picornaviruses, Poxiviruses, Rhabdoviruses, Reoviruses, Retroviruses, and Togaviruses.

In another embodiment the virus is selected from the group consisting of: Norovirus (Norwalk virus), Poliovirus, Rotavirus, Respiratory Syncytial Virus, Rhinovirus, Parainfluenza Virus, Coronavirus, Influenza A and B viruses, Human Immunodeficiency Virus (HIV), Hepatitis A virus, Hepatitis B virus, Hepatitis C virus, Herpes simplex virus type 1, and Herpes simplex virus type 2.

In another embodiment the viruses are small non-enveloped viruses. Examples of small non-enveloped viruses include, but are not limited to, picornaviruses, such as human rhinovirus A, human rhinovirus B, Foot-and-mouth disease virus, Hepatitis A virus, and enteroviruses (such as poliovirus).

In a preferred embodiment, the viruses are enteroviruses.

### Surfactants

The method of the invention may include application of a surfactant (for example, as part of a detergent formulation or as a wetting agent). Surfactants suitable for being applied may be non-ionic (including semi-polar), anionic, cationic and/or zwitterionic; preferably the surfactant is anionic (such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap) or non-ionic (such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”)), or a mixture thereof.

When included in the method of the invention, the concentration of the surfactant will usually be from about 0.01% to about 10%, preferably about 0.05% to about 5%, and more preferably about 0.1% to about 1% by weight.

### Methods and Uses

In a first aspect, the present invention provides an enzymatic method for inactivating a virus, comprising contacting the virus with a composition which includes a haloperoxidase, a source of hydrogen peroxide, chloride ions and/or bromide ions, and ammonium ions. In a preferred embodiment, the present invention provides a method for disinfecting or sterilizing medical devices or equipment, which comprises contacting the medical devices or equipment with the composition.

The composition may be formulated as a liquid (e.g. aqueous) or a dry product formulation. The dry product formulation may subsequently be re-hydrated to form an active liquid or semi-liquid formulation usable in the method of the invention.

When the composition is formulated as a dry formulation, the components may be mixed, arranged in discrete layers or packed separately.

In a second aspect, the invention also covers a composition which results from applying the method of the invention. In this case, the composition comprises a haloperoxidase, hydrogen peroxide, chloride ions and/or bromide ions, ammonium ions, active or inactive viruses, and a medical device or equipment.

The method of the invention is useful for decontamination of locations which have been exposed to viruses, such as biological warfare agents.

In the context of the present invention the term “inactivating viruses” is intended to mean that at least 99% of the viruses are not capable of infecting suitable cells. Preferably 99.9%, more preferably 99.99%, most preferably 99.999%, and in particular 99.9999% of the viruses are not capable of infecting suitable cells.

In an embodiment, the term “disinfecting” or “disinfection” refers to high level disinfection according to “Content and Format of Premarket Notification [510 (k)] Submissions for Liquid Chemical Sterilants/High Level Disinfectants”, U.S. Food and Drug Administration, January 2000.

The methods according to the invention may be carried out at a temperature between 0 and 70 degrees Celsius, preferably between 5 and 60 degrees Celsius, more preferably between 10 and 60 degrees Celsius, even more preferably between 15 and 60 degrees Celsius, even more preferably between 20 and 60 degrees Celsius, most preferably between 20 and 50 degrees Celsius, and in particular between 20 and 40 degrees Celsius.

The methods of the invention may employ a treatment time of from 10 minutes to (at least) 4 hours, preferably from 15 minutes to (at least) 3 hours, more preferably from 20 minutes to (at least) 2 hours, most preferably from 20 minutes to (at least) 1 hour, and in particular from 30 minutes to (at least) 1 hour.

The method of the invention is suitable for inactivating viruses in a variety of environments. The method of the invention may desirably be used in any environment to reduce virus infections, such as the health-care industry (e.g. animal hospitals, human hospitals, animal clinics, human clinics, nursing homes, day-care facilities for children or senior citizens, etc.), the food industry (e.g. restaurants, food-processing plants, food-storage plants, grocery stores, etc.), the hospitality industry (e.g. hotels, motels, resorts, cruise ships, etc.), the education industry (e.g. schools and universities), etc.

Due to the relatively low temperatures being utilized by the methods of the invention, they are very useful for disinfecting or sterilizing equipment, such as medical devices (e.g. dry surgical instruments, anesthesia equipment, hollowware etc), used in the health-care industry. The disinfected or sterilized equipment will exhibit reduced deformations and wear, and the equipment is ready for use substantially immediately after disinfection or sterilization. This is especially advantageous when disinfecting or sterilizing complex or heat sensitive medical devices such as ultrasound transducers and endoscopes comprising different materials, because the wear of these devices have been reduced significantly, which results in longer service life of these often very costly devices, which effectively reduces their operational cost. Indeed, even other non-medical types of equipment such as reusable hygienic articles may be disinfected or sterilized effectively by use of the present invention.

In a preferred embodiment, the disinfection or sterilization of medical devices and/or non-medical types of equipment takes place in a (Medical) Washer-Disinfector according to EN ISO 15883-1 (or as described in “Class II Special Controls Guidance Document: Medical Washers and Medical Washer-Disinfectors; Guidance for the Medical Device Industry and FDA Review Staff”, U.S. Food and Drug Administration, February 2002), using the methods of the invention.

The method of the invention may desirably be used in any environment to reduce virus infections, such as general-premise surfaces (e.g. floors, walls, ceilings, exterior of furniture, etc.), specific-equipment surfaces (e.g. hard surfaces, manufacturing equipment, processing equipment, etc.), textiles (e.g. cottons, wools, silks, synthetic fabrics such as polyesters, polyolefins, and acrylics, fiber blends such as cottonpolyester, etc.), wood and cellulose-based systems (e.g. paper), soil, animal carcasses (e.g. hide, meat, hair, feathers, etc.), foodstuffs (e.g. fruits, vegetables, nuts, meats, etc.), and water.

In one embodiment, the method of the invention is directed to virucidal treatment of textiles. Examples of textiles that can be treated with the composition of the invention include, but are not limited to, personal items (e.g. shirts, pants, stockings, undergarments, etc.), institutional items (e.g. towels, lab coats, gowns, aprons, etc.), hospitality items (e.g. towels, napkins, tablecloths, etc.).

A virucidal treatment of textiles with a composition of the invention may include contacting a textile with a composition of the invention. This contacting can occur prior to laundering the textile. Alternatively, this contacting can occur during laundering of the textile to provide virucidal activity and optionally provide cleansing activity to remove or reduce soils, stains, etc. from the textile.

The viruses which are contacted by the composition of the invention may be located on any surface including, but not limited to, a surface of a process equipment used in e.g. a dairy, a chemical or pharmaceutical process plant, a medical device such as an endoscope or other medical utensils, a piece of laboratory equipment, a washing machine, or a water sanitation system. The composition of the invention should be used in an amount, which is effective for inactivating the viruses on the surface in question.

The viruses may be contacted by the composition used in the method of the invention by submerging the viruses in an aqueous formulation of the composition (e.g. a laundering process), by spraying the composition onto the viruses, by applying the composition to the viruses by means of a cloth, or by any other method recognized by the skilled person. Any method of applying the composition of the invention to the viruses, which results in inactivating the viruses, is an acceptable method of application.

The method of the invention is also useful for decontamination of locations which have been exposed to viruses (e.g. pathogenic viruses), such as biological warfare agents. Such locations include, but are not limited to, clothings (such as army clothings), inner and outer parts of vehicles, inner and outer parts of buildings, any kind of army facility, and any kind of environment mentioned above.

The present invention is further described by the following examples which should not be construed as limiting the scope of the invention.

### EXAMPLES

Chemicals used as buffers and substrates were commercial products of at least reagent grade.

### Example 1

### Inactivation of Poliovirus

### Virus and Cells

The poliovirus strain Sabin (Type 2H.010704) obtained from WHO was propagated in VERO cells at 34.5° C., 5% CO₂ using Eagles MEM 2% FCS, 100 IU/mL penicillin, 100 mg/mL streptomycin, and 20 μg/mL gentamycin. Culture supernatant was filtered (0.45 nm), aliquoted and stored at −80° C. until use.

### Stock Solutions

The following stock solutions were prepared.

Solution 1: 22.8 mM NaCl and 7.2 mM NH₄Cl in 20 mM DMG (Sigma D4379) buffer pH 7.0;
Solution 2: 10% H₂O₂ in MilliQ water;
Solution 3: 8000 ppm haloperoxidase from Curvularia verruculosa (see SEQ ID NO:2 in WO 97/04102) in 20 mM DMG buffer pH 7.0;

### Phosphate Buffered Saline

### Disinfectant Solution

To create approximately 50 mL of active disinfecting solution, the following was mixed: 50 mL solution 1; 62 μL solution 2; and 100 μL solution 3. The undiluted disinfecting solution was further diluted with phosphate buffered saline (PBS) to give 1:10 and 1:100 solutions.

### Cell Culture Media

Eagles MEM media supplemented with 4% fetal calf serum, 100 IU/mL penicillin, 100 mg/mL streptomycin and 20 μg/mL gentamycin.

### Treatment of Virus

In a microtiter plate 50 μL of the test solution was mixed with 50 μL of a diluted polio virus stock in PBS and incubated at 34.5° C. for 1 hour.

In order to compare the enzymatic disinfection solution to a known disinfectant, sodium hypochlorite was used as a control at concentrations of 0.5%, 0.05% and 0.005%

For all treatments a control without virus addition was made in order to identify any cytotoxic effects of the test solutions on the cell line. In addition a positive control of virus infectivity was included in which no disinfecting solution was added.

To assay for remaining infective virus after the treatment, 100 μL of the test solutions and 100 μL Eagles minimal media with 4% FCS was added to a fresh microtiter plate in which confluent growth of the RD cell line (human rhabdomyosarcoma) had been established. This plate was incubated for 5 days at 34.5° C. and 5% CO₂, before infectivity and cytotoxicity was scored by an expert evaluator using a microscope.

TABLE 1
Results from antiviral testing of
Poliovirus Sabin (Type 2H.010704).

| | 1 | 2 | 3 | 4 | 5 | 6 | 7 |
|---|---|---|---|---|---|---|---|
| | Control | En- | En- | En- | Hypo- | Hypo- | Hypo- |
| | (no | zyme | zyme | zyme | chlorite | chlorite | chlorite |
| | enzyme) | 1:1 | 1:10 | 1:100 | 0.5% | 0.05% | 0.005% |
| No | N | N* | N | N | N* | N | N |
| virus | N | N* | N | N | N* | N | N |
| added | N | N* | N | N | N* | N | N |
| | N | N* | N | N | N* | N | N |
| Virus | I | N* | N | N | N* | N | N |
| added | I | N* | N | N | N* | N | N |
| | I | N* | N | N | N* | N | N |
| | I | N* | N | N | N* | N | N |

### Enzyme: Haloperoxidase

Hypochlorite: Sodium hypochlorite

### I: Infection

N: No infection
N*: No infection with a slight toxic effect

### T: Toxic

The results show that the method of the invention inhibited poliovirus (lane 2-4) to the same extend as sodium hypochlorite (lane 5-7). The assay was performed in duplicate. The enzyme system showed strong virucidal activity, even down to a 1:100 dilution.

### Example 2

### Inactivation of HIV-1 virus

### Virus and Cells

The HIV-1 strain HTLV-IIIB (NIH AIDS Research and Reference Program) was propagated in H9 cells (NIH AIDS Research and Reference Program) at 37° C., 5% CO₂ using RPMI 1640 with 10% heat inactivated fetal calf serum (FCS), 100 IU/mL penicillin, 100 mg/mL streptomycin, 20 μg/mL gentamycin, and 10 IU/mL nystatin. Culture supernatant was filtered (0.45 nm), aliquoted and stored at −80° C. until use.

### Stock Solutions

The following stock solutions were prepared.

Solution 1: 22.8 mM NaCl and 7.2 mM NH₄Cl in 20 mM DMG (Sigma D4379) buffer pH 7.0;
Solution 2: 10% H₂O₂ in MilliQ water;
Solution 3: 8000 ppm haloperoxidase from Curvularia verrucolosa (see SEQ ID NO:2 in WO 97/04102) in 20 mM DMG buffer pH 7.0;

### Phosphate Buffered Saline

### Disinfectant Solution

To create approximately 50 mL of active disinfecting solution, the following was mixed: 50 mL solution 1; 62 μL solution 2; and 100 μL solution 3.

The undiluted disinfecting solution was further diluted with phosphate buffered saline (PBS) to give 1:10 and 1:100 solutions.

### Cell Culture Media

RPMI 1640 Glutamax (Sigma R8758) supplemented with 100 IU/mL penicillin, 100 mg/mL Streptomycin, 20 μg/mL gentamycin, 10 IU/mL Nystatin and 5% fetal calf serum.

### MTT Reagent

### 50 mg MTT (Sigma M5655)

### 10 mL PBS pH 7.4

### MTT Stop Reagent

### 10 mL Triton X-100 (Sigma T8787)

### 4 mL 1M HCl

isopropanol to 100 mL

### Treatment of Virus

In a microtiter plate 50 μL of the test solution was mixed with 50 μL of a diluted HIV virus stock in PBS and incubated at 37° C. for 5 min.

In order to compare the enzymatic disinfection solution to a known disinfectant, sodium hypochlorite was used as a control at concentrations of 0.5%, 0.05% and 0.005%.

For all treatments a control without virus addition was made in order to identify any cytotoxic effects of the test solutions on the cell line. In addition a positive control of virus infectivity was included in which no disinfecting solution was added.

To assay for remaining infective virus after the treatment, 100 μL of the test solutions and 100 μL RPMI1640 cell media with 5% FCS containing 0.3×10³ MT4 cells/mL was added to a fresh microtiter plate. This plate was incubated for 6 days at 37° C. and 5% CO₂, before viability was measured in a MTT assay. 30 μL MTT reagent was added to each well and the plate was incubated for 1 hour at 37° C. 150 μL of the solution was removed and replaced with 130 μL MTT stop solution and the content was mixed.

Absorbance was measured in a plate reader at 540 nm with absorbance at 690 nm as reference. Based on the absorbance, each well was scored to be either infected or non-infected in the virus containing wells; and toxic or non-infected in the control wells for cytotoxicity.

TABLE 2
Results from antiviral testing of HIV-1 virus (Strain HTLV-IIIB).

| | 1 | 2 | 3 | 4 | 5 | 6 | 7 |
|---|---|---|---|---|---|---|---|
| | Control | En- | En- | En- | Hypo- | Hypo- | Hypo- |
| | (no | zyme | zyme | zyme | chlorite | chlorite | chlorite |
| | enzyme) | 1:1 | 1:10 | 1:100 | 0.5% | 0.05% | 0.005% |
| No | N | T | T | N | T | T | T |
| virus | N | T | T | N | T | T | T |
| added | N | T | T | N | T | T | T |
| | N | T | T | N | T | T | T |
| Virus | I | T | T | N | T | T | T |
| added | I | T | T | N | T | T | T |
| | I | T | T | N | T | T | T |
| | I | T | T | N | T | T | T |

### Enzyme: Haloperoxidase

Hypochlorite: Sodium hypochlorite

### I: Infection

N: No infection
N*: No infection with a slight toxic effect

### T: Toxic

The results show that the method of the invention had an antiviral effect on HIV virus in a 1:100 dilution (lane 4) during an incubation period of 5 min.

### REFERENCE

(1983) Rapid colorimetric assay for cellular growth and survival: Application to proliferation and cytotoxicity assays. J. 1 mm. Meth, 65, 55-63.

1. An enzymatic method for inactivating a virus, which comprises contacting the virus with a haloperoxidase, hydrogen peroxide, chloride and/or bromide ions, and ammonium ions.

2. The method of claim 1, wherein the haloperoxidase is a chloroperoxidase from enzyme class EC 1.11.1.10.

3. The method of claim 1, wherein the haloperoxidase is a vanadium containing haloperoxidase.

4. The method of claim 3, wherein the amino acid sequence of the haloperoxidase has at least 90% identity, preferably 95% identity to the amino acid sequence of a haloperoxidase obtainable from Curvularia verruculosa or Curvularia inequalis.

5. The method of claim 1, wherein the chloride ions and/or bromide ions are derived from salts of chloride and/or bromide; preferably the salts of chloride and/or bromide include sodium chloride, sodium bromide, potassium chloride, potassium bromide, ammonium chloride or ammonium bromide.

6. The method of claim 1, wherein the ammonium ions are derived from an ammonium salt; preferably the ammonium salt is ammonium sulphate, ammonium carbonate, ammonium phosphate, ammonium chloride, ammonium bromide or ammonium iodide; or a mixture thereof.

7. The method of claim 1, wherein the concentration of chloride ions is at least two times higher than the concentration of ammonium ions; preferably at least four times higher, more preferably at least six times higher, most preferably at least eight times higher, and in particular at least ten times higher than the concentration of ammonium ions.

8. The method of claim 1, which further comprises contacting the virus with a surfactant.

9. The method of claim 1, wherein the virus is a non-enveloped virus, such as a small non-enveloped virus.

10. The method of claim 1, wherein the virus is an enterovirus.

11. The method of claim 1, wherein the virus is poliovirus.

12. The method of claim 1, wherein the virus is located on a surface, such as a surface of a medical device or equipment.

13. The method of claim 1, which is a method of high level disinfection.

14. (canceled)

15. (canceled)
